(19) United States
(12) Patent Application Publication
(10) Pub. No.: US 2007/0285774 A1
(43) Pub. Date: Dec. 13, 2007

(54) AUGMENTING BRIGHTNESS PERFORMANCE OF A BEAM-SPLITTER IN A STEREOSCOPIC DISPLAY

(75) Inventors: John O. Merrirt, Williamsburg, MA (US); German Von Thal, Santa Maria, CA (US)

Correspondence Address: CANADY & LORTZ LLP - BOEING, 2540 HUNTINGTON DRIVE, SUITE 205, SAN MARINO, CA, 91108, US

(73) Assignee: The Boeing Company, Chicago, IL (US)

(21) Appl. No.: 11/423,663

(22) Filed: Jun. 12, 2006

(51) Int. Cl. G02B 27/26

(52) U.S. Cl. 359/465; 359/462

(57) ABSTRACT

An apparatus and method is disclosed for increasing the light output of a stereoscopic three-dimensional display system by reducing the light losses typically present when using a conventional beam-combining half-mirror, i.e. a beam splitting device (BSD). The separate outputs of two LCD monitors are optically superimposed, one for the left eye and one for the right eye of a user, in order to produce a brighter stereoscopic three-dimensional display. By selecting angles of linear polarization for the rear and the side LCD monitors or other display devices, embodiments of the invention can achieve as much as 60/60 efficiency for the display pair, according to the Fresnel laws of reflection regarding polarization. This intensity increase can provide a viewer a significantly brighter picture and allow the installation environment of the stereoscopic display to maintain higher ambient lighting conditions. Embodiments of the invention also can achieve both, a more efficient polarizer orientation, and the required mirror-image reversal in one simple step.

### CROSS-REFERENCE TO RELATED APPLICATIONS

This application is related to the following co-pending U.S. Patent application which is incorporated by reference herein:

U.S. patent application Ser. No. ______, filed on the same day herewith, by Hewitt et al. and entitled “EFFICIENT AND ACCURATE ALIGNMENT OF STEREOSCOPIC THREE-DIMENSIONAL DISPLAYS”.

### BACKGROUND OF THE INVENTION

1. Field of the Invention

This invention relates to stereoscopic three-dimensional displays. Particularly, this invention relates to systems and methods for enhancing brightness of stereoscopic three-dimensional displays, such as may be employed in aerospace applications.

2. Description of the Related Art

Conventional stereoscopic three-dimensional display systems employing beam splitter devices (BSDs) to present separate images to each eye of a user have limited light output. In general, this limited light output is a consquence of their fundamental operating principle where source light from two separate displays is each split into two output directions, a reflected output and a transmitted output. Approximately 50% of the source light is transmitted and approximately 50% of the light is reflected for a randomly polarized light source. One of the displays delivers polarized transmitted light to one eye of the user through the BSD, which is approximately 50% of the light originating from that display. The other one of the displays delivers differently polarized reflected light to the other eye of the user through the BSD, which is approximately 50% of the light originating from that display. Thus, each eye only receives approximately 50% of the available light. The different polarizations of the displays are used to isolate the images from the each display to a separate eye through polarization filtering. Various stereoscopic three-dimensional display systems have been developed.

U.S. Pat. No. 4,298,176 by Kendall, issued Nov. 3, 1981, describes a refueling system, for use in a tanker aircraft from a remote location without a direct out-the-window view of the refueling operation, having enhanced three-dimensional viewing of the refueling operation by use of multiple video cameras, polarized video monitors and cross-polarized eye glasses together with controls for movement of the boom tip in elevation and azimuth, as well as controls for extension of the boom tip.

U.S. Pat. No. 6,703,988 by Fergason, issued Mar. 9, 2004, describes a display system or monitor arrangement for stereoscopic three-dimensional displaying of images including a pair of displays for providing respective left eye and right eye images and arranged in perpendicular intersecting planes, a beam splitter for combining the images from the displays in a common light path, and a means to discriminate between respective images to present the respective left and right eye images to the eyes of a viewer for viewing. Image discriminating functions may be obtained using plane polarized light characteristics and/or circular polarized light characteristics. A package arrangement retains the display a system components for storage or use; and a cubical mount structure may provide alignment and positioning of respective parts of the display system. Display methods for displaying stereoscopic images in a common light path are included.

U.S. Pat. No. 6,593,957 by Christie, issued Jul. 15, 2003, describes autostereoscopic image displays providing realistic three-dimensional images to one or a plurality of viewers without the need for wearable appliances. In some embodiments, the images are viewed through a beamsplitter, while in other embodiments the viewer observes the images on a display screen. A viewer-tracking system monitors the viewer's movements and directs each image of a stereopair to the proper eye of the viewer. In some embodiments, the stereoimages are kept independent and separately directed through differential polarization. In other embodiments, this is accomplished through selective intensity modulation.

U.S. Pat. No. 5,976,017 by Omori et al., issued Nov. 2, 1999, describes a stereoscopic-image game playing apparatus displaying a screen image for right eye and a screen image for left eye on an LCD, outputs images of the player obtained by cameras to the receiving side, and displays images corresponding to the right half face and the left half face of the player based on the player's images on a second LCD. The images displayed on the second LCD are used as figures for selectively introducing lights from the screen images on the first LCD, by a lens, to the right and left eyes of the player. This enables stereoscopic vision without glasses for separating images respectively for the player's right and left eyes, and allows the player to move from the initial position.

U.S. Pat. No. 5,644,427 by Omori et al., issued Jul. 1, 1997, describes screen images for the right eye and for the left eye are displayed upside down on two image display devices, respectively, and images of right half and left half faces of the viewers picked-up by two image sensing devices are displayed on two spatial modulation elements. By seeing the screen images transmitted through the images of the right half and the left half faces, which are light transmission images, on the spatial modulation elements, and through lenses, having directivities, the right eyes and the left eyes of the viewers can respectively see the screen images for the right eyes and for the left eyes, which are combined by a half mirror.

U.S. Pat. No. 6,069,649 by Hattori, issued May 30, 2000, describes a stereoscopic three-dimensional display which enables plural persons to simultaneously observe stereoscopic images includes a color liquid crystal plate for displaying stereo-pairs composed of left and right eye perspectives in time-interlaced manner, a monochrome TV display disposed behind the color liquid crystal plate for displaying binary and inverted binary images of half face of each observer so as to be synchronized with the time-interlaced display of the color liquid crystal plate, and a large convex lens disposed between the color liquid crystal plate and the monochrome TV display so as to focus the observers' optical images on the screen of the monochrome TV display in geometrical agreement with the observers' face images displayed thereby. And an infrared TV camera is disposed so as to take observers' images by way of the large convex lens and input observers' face images to the monochrome TV display.

U.S. Pat. No. 5,774,175 by Hattori, issued Jun. 30, 1998, describes a stereoscopic television which enables plural observers to simultaneously observe a stereoscopic images includes a color liquid-crystal plate, a monochrome TV display disposed behind the liquid-crystal plate, and a large format lens disposed between the color liquid-crystal plate and the monochrome TV display so as to focuss the observer's image on the screen of the TV display. The color liquid-crystal plate alternately displays stereo-pairs composed of left and right eye perspectives, and the monochrome TV display alternately displays inverted binary images of half face of each oberver. The large format lens distrubutes light emitted from the inverted binary images of half face of each observer to the left and right eyes of each observer through the color liquid-crystal plate, whereby the left and right eye perspectives of the stereo-pairs displayed by the liquid-crystal plate respectively reach the left and right eyes of each observer.

However, as previously mentioned, conventional stereoscopic display systems, such as those described above, provide limited light output. There is a need in the art for apparatuses and methods for stereoscopic display system to operate with enhanced brightness. Similarly, there is a need for such systems and methods to operate in BSD stereoscopic display systems which employ LCD displays. There is also a need for such systems and methods to be used in systems for the remote operation of an aircraft appendage, such as a refueling boom. As detailed hereafter, theses and other needs are met by the present invention.

### SUMMARY OF THE INVENTION

Embodiments of the invention provide a way to increase the light output of a stereoscopic three-dimensional display system by reducing the light losses typically present when using a conventional beam-combining half-mirror, i.e. a beam splitting device (BSD). The separate outputs of two LCD monitors are optically superimposed, one for the left eye and one for the right eye of a user, in order to produce a brighter stereoscopic three-dimensional display. By selecting angles of linear polarization for the rear and the side LCD monitors or other display devices, embodiments of the invention can achieve as much as 60/60 efficiency for the display pair, according to the Fresnel laws of reflection regarding polarization. This intensity increase can provide a viewer a significantly brighter picture and allow the installation environment of the stereoscopic display to maintain higher ambient lighting conditions. Embodiments of the invention also can achieve both, a more efficient polarizer orientation, and the required mirror-image reversal in one simple step.

A typical embodiment of the invention comprises a three-dimensional stereoscopic display including a beam splitter device having a p-polarization transmittance of greater than 50% and an s-polarization reflectance of greater than 50%. A p-polarized display is disposed to transmit a first image through the beam splitter device to a common viewing aperture and an s-polarized display is disposed to reflect a second image through the beam splitter device to the common viewing aperture. The first image is p-polarization filtered to a first eye and the second image is s-polarization filtered to a second eye through the common viewing aperture to display a stereoscopic image. The p-polarization transmittance can be at least substantially 60% and the s-polarization reflectance can be at least substantially 60%. The beam splitter device may include an optical coating to substantially balance the p-polarization transmittance with the s-polarization reflectance.

In a typical configuration, the beam splitter device may be disposed at substantially forty-five degrees relative to both the p-polarized display and the s-polarized display. The p-polarized display can be disposed behind the beam splitter device and the s-polarized display can be disposed on one side of the beam splitter device. Further, the p-polarized display and the s-polarized display may each comprise an LCD display. In one particular example, the s-polarized display comprises an LCD panel reversed relative to a backlight to easily produce the proper polarization as well as reversing the image (required for the reflected display).

In further embodiments, the device can include one or more lenses disposed in the common viewing aperture. In some embodiments, two plano-convex lenses may be used in the viewing aperture to enlarge the apparent size of the stereoscopic image to a viewer.

In a similar manner, a typical method embodiment of the invention for a three-dimensional stereoscopic display includes the operations of transmitting a first image from a p-polarized display through a beam splitter device having a p-polarization transmittance of greater than 50% to a common viewing aperture, filtering the first image from the common viewing aperture with a p-polarization filter to a first eye, reflecting a second image from an s-polarized display through the beam splitter device having an s-polarization reflectance of greater than 50% to the common viewing aperture, filtering the second image from the common viewing aperture with an s-polarization filter to a second eye through the common viewing aperture, and viewing the first p-polarization filtered image and the second s-polarization filtered image to display a stereoscopic image. The method embodiment of the invention may be further modified consistent with the apparatus embodiments.

### BRIEF DESCRIPTION OF THE DRAWINGS

Referring now to the drawings in which like reference numbers represent corresponding parts throughout:

FIG. 1A illustrates a basic configuration of a conventional display with a BSD in a stereoscopic three-dimensional display system;

FIG. 1B is a plot of reflectance versus angle of incidence for s-polarized and p-polarized light;

FIG. 1C is a plot of reflectance and transmittance versus angle of incidence for s-polarized light;

FIG. 1D is a plot of reflectance and transmittance versus angle of incidence for p-polarized light;

FIG. 1E is a plot of reflectance and transmittance versus wavelength;

FIG. 1F illustrates an enhanced brightness display with a BSD in a stereoscopic three-dimensional display system;

FIGS. 2A and 2B illustrates an exemplary system incorporating enhanced brightness in accordance with the invention;

FIGS. 3A and 3B illustrates an exemplary stereoscopic three-dimensional display incorporating enhanced brightness in accordance with the invention; and

FIG. 4 is a flowchart of an exemplary method for displaying a stereoscopic three-dimensional image with enhanced brightness.

### DETAILED DESCRIPTION OF THE PREFERRED EMBODIMENT

1. Overview

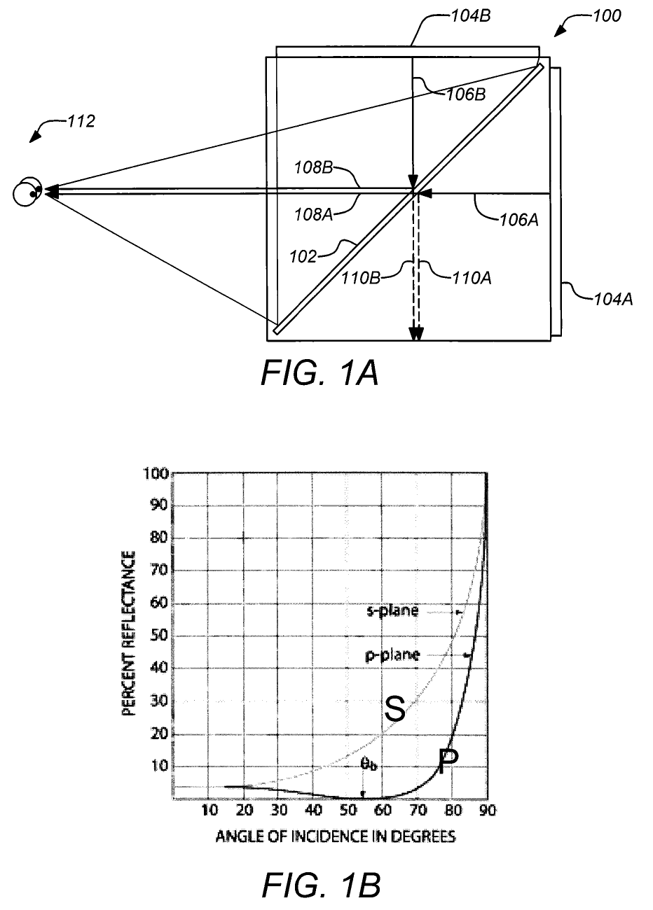

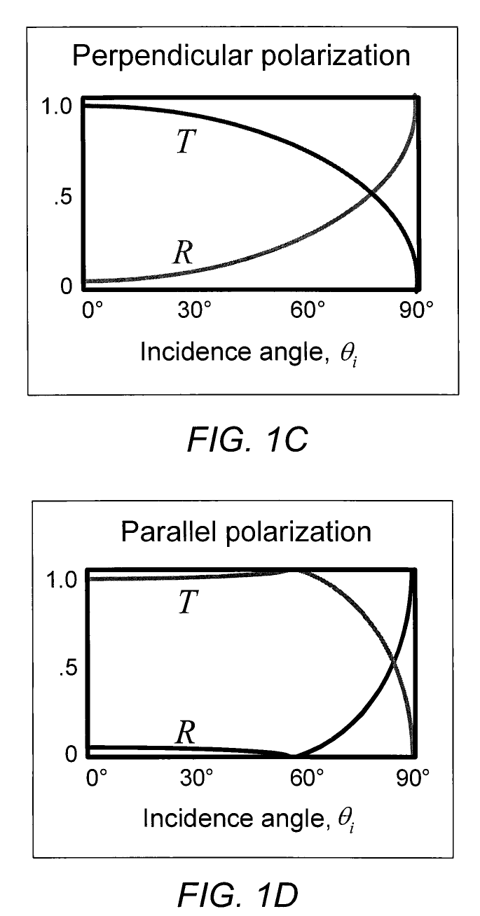

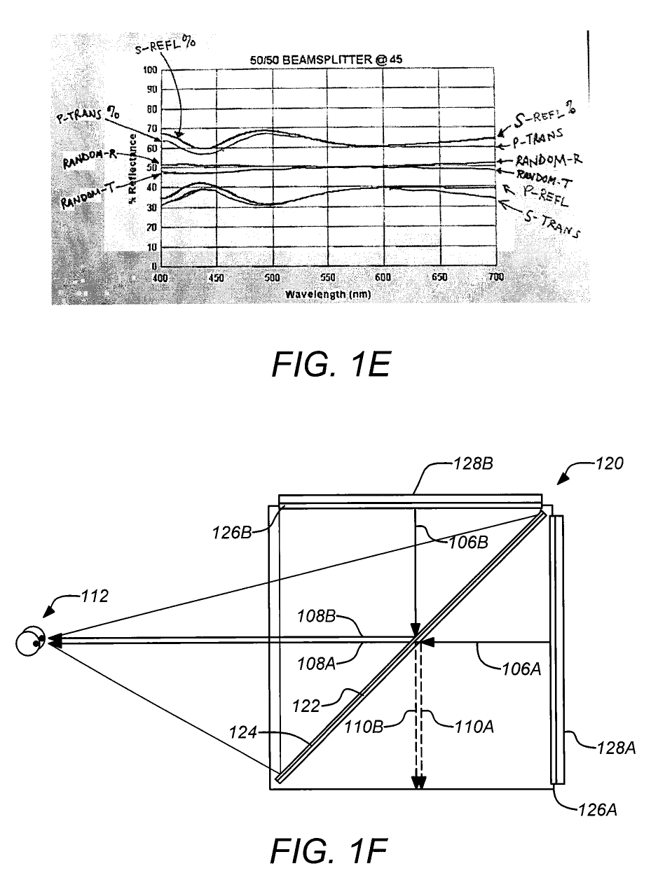

FIG. 1A illustrates a conventional stereoscopic three-dimensional display system 100 arrangement employing a BSD 102. To illustrate the present invention, operation of the system 100 can first be described as a conventional system. Each display device 104A, 104B directs differently polarized image light to the BSD 102, e.g. polarized along two different diagonals relative to the BSD. At most 50% of incoming polarized image light 106A from the rear display device 104A is transmitted through the BSD 102 to become the transmitted image 108A for one eye, e.g. the right eye. The remaining reflected light 110A is wasted, reflected away and absorbed by a black wall. In a similar manner, at most 50% of the incoming polarized image light 106B from the side display device 104B is reflected off the BSD 102 to become the reflected image 108B for the other eye, e.g. the left eye. The remaining transmitted light 110B is wasted, transmitted through the BSD 102 and also absorbed by a black wall. Thus, the observer 112 receives only half of the generated light from a dual light source system designed for left and right eye vision such as in a stereoscopic three-dimensional display 100. The observer 112 gets, at most, 50% to the right eye, e.g. filtered to match the diagonal polarization of one display 104A, and 50% to the left eye, filtered to match the diagonal polarization of the other display 104B. In order to give the observer 112 adequate viewing (intensity, contrast, etc.), installation of typical display systems often requires a low-light level environment for satisfactory operation. As described, conventional three-dimensional display systems employing BSDs to form a stereoscopic image have limited light output.

Although it is not possible to split a single input light source into a 60/60 pair of outputs with a beam splitter, it is possible to achieve a 60/60 pair of outputs when the outputs are combined as portions portions of two separate light source inputs (e.g. the separate LCD monitors). Thus, by taking advantage of proper light polarization and reflecting/transmission coatings, the output light can effectively be increased by approximately 10%; the total output becomes a 60/60 combination, with each part representing the captured light portion of each input monitor. Also note that by reflecting s-polarized light and transmitting p-polarized in the beam splitter device, the brighter outputs are both directed out of the same side of the beam splitter device, i.e. the viewer side.

Embodiments of the may utilize the same general configuration of components as illustrated in FIG. 1A with some key differences. Embodiments of the invention employ a pair of displays (e.g. LCD, CRT, or any other known display device) adapted with a polarizer. One display is s-polarized and the other display is p-polarized. In addition, special coatings can be employed to optimize the BSD properties. For example, to equalize luminance of both displays as seen by the user the upper surface may be partially reflective due to metallized coatings or multi-layer dielectric coatings. To minimize secondary reflections from the back surface of the BSD glass, the lower surface may be treated with an anti-reflective coating, such as magnesium fluoride. Other coatings known to those skilled in the art may be similarly employed to obtain the necessary optical properties.

2. Stereoscopic Display Brightness with a Beam-Splitter

Embodiments of the invention can enhance the light-throughput efficiency of a beam-combining half-mirror (i.e. a beam splitting device) used to optically superimpose the left eye and right eye views in a stereoscopic three-dimensional display. Enhanced brightness can improve visual comfort in this type of stereoscopic display by stopping down the user's pupils, thus increasing the depth of focus. This can permit longer, sustained use of the stereoscopic three-dimensional display.

When a ray of light impinges on an air-glass surface at an angle close to 45 degrees, nearly all of the reflected light is s-polarized, whereas almost none of the p-polarized light is reflected. According to Fresnel's laws of reflection, s-polarized light is more efficiently reflected, whereas p-polarized light is more efficiently transmitted, and this guides the choice for the orientation of the front polarizers on LCD panels used to make up a dual-display beamplitter-type three-dimensional stereoscopic display. If the rear LCD display of a stereoscopic display system is modified to have a vertical axis of polarization (p-polarization), while the side LCD monitor has a horizontal axis of polarization (s-polarization), the beamsplitter efficiencies will increase from 50/50, as a theoretical maximum, to 60/60 or more, due to the more efficient utilization of the natural tendencies of the beamsplitter device. Because most of the newer larger LCD monitors come from the factory with a vertical axis of polarization it is possible to use an unmodified LCD monitor in the back, to be viewed through the beamsplitter, whereas the top monitor, seen reflected in the beamsplitting mirror, should be polarized horizontally. Incidentally, previous LCD monitors, e.g. 17″ diagonal monitors and below, were nearly all diagonally polarized.

The polarization of the side LCD monitor can be altered from vertical (p) to horizontal (s) by a number of techniques. For example, the front and back polarizers can be stripped from the LCD glass and replaced with polarizers rotated 90 degrees to their original orientation. Various “half-wave retarder” sheets can be applied to the existing front polarizer in order to rotate the original axis of polarization from vertical to horizontal. A “quarter-wave retarder” sheet can be used to create circular polarization which is reversed in handedness by the beamsplitter to permit separation of the left and right eye channels.

One particularly efficient technique for modifying the side display is to remove the entire LCD panel, with its polarizers intact, flip it over and replace it on the monitor's backlight. By simply reversing the LCD panel relative to the backlight in this manner, the axis of polarization is changed from vertical to horizontal and the contents on the monitor become a mirror image, which is necessary for viewing the side monitor reflected from the beamsplitting mirror. Ordinarily, the image on the side monitor would have to be reversed electronically (e.g. in the video processor), which may cause processing delays, but by simply flipping the LCD panel on the backlight, both the image reversal and the polarization reversal are accomplished at the same time.

FIG. 1B is a graph showing percent reflectance of both a vertical (p) axis of polarization and a horizontal (s) axis of polarization from a sheet of ordinary uncoated glass at varying angles incidence. The angle of incidence can be defined as 90 degrees minus the angle between the incident light rays and the surface of the flat glass panel. Thus, at a 60 degrees angle of incidence the incident light rays form an angle of 30 degrees with the glass surface.

It can be seen that both s-polarization reflectance and p-polarization reflectance at the uncoated air-glass interface remain close to approximately 4% over the first 25 degrees of incidence angle, then they diverge. Past 60 degrees both rise rapidly to nearly 100% as the light rays become more and more inclined to the glass. It can be seen that s-polarized and p-polarized light have similar reflectance and transmittance curves for small angles of incidence, but diverge considerably after 30 degrees. However, the curves converge again as they approach 90 degrees.

Referring back to FIG. 1A it can seen in a typical stereoscopic display 100 that there is a range of incidence angles on the beam spitter device. Light from the side display 104B has a 45 degree angle of incidence at the center of the BSD 102. However, the angle of incidence is approximately 30 degrees where it strikes the BSD 102 in the lower left corner and approximately 60 degrees where it strikes the BSD 102 in the upper right corner. Similarly, light from the rear display 104A goes through this range of angles of incidence across the surface of the BSD 102. Thus, when incident at approximately 45 degrees in the center of a 50/50 beamsplitter, about 60% of s-polarized light is reflected, while about 60% of p-polarized light is transmitted. Note that at other incidence angles (e.g. the approximately 30 degrees at the bottom of the beamsplitter and the approximately 60 degrees at the top of the beamsplitter), the s-polarization reflectance and the p-polarization transmittance curves (from approximatley 450-650 nm wavelength) will differ from those at approximately 45 degrees at the center. Note that although this range of incidence angles occurs for a given sterescopic display designs(and the attendant range of transmittance and reflectance properties), a single transmittance and reflectance property may be assigned to a give BSD referring to the center angle of incidence for the design, e.g. approximately 45 degrees as used in the example embodiments herein. Other angles of incidence should be applied as appropriate to other stereoscopic display designs within the scope of the invention as will be understood by those skilled in the art.

FIG. 1C is a plot of reflectance (R) and transmittance (T) versus angle of incidence for s-polarized light. FIG. ID is a plot of reflectance (R) and transmittance (T) versus angle of incidence for p-polarized light. Note that R+T=1.0 at every angle of incidence. To minimize the losses in a 45 degree beam-combining half-mirror (i.e. BSD), the image to be reflected is s-polarized and the image to be transmitted is p-polarized. For uncoated glass, nearly 99% of p-polarized light will be transmitted, leaving room to add coatings to increase the reflection of the s-polarized light from approximately 10% (for uncoated glass) to approximately 60%. In turn, this increase in s-polarization reflection cuts the transmitted p-polarized light from nearly 100% to approximately 60%. Thus, an optical coating can be used to substantially balance the p-polarization transmittance with the s-polarization reflectance in order to optimize the overall brightness of the stereoscopic display. Note that “perpendicular” and “parallel” in FIGS. 1C and 1D refer to the angle between the axis of polarization and the plane of incidence.

FIG. 1E is a plot of reflectance and transmittance versus wavelength. The plot shows calculated reflectance and transmittance of a “50/50” coated beamsplitter, at an incidence angle of 45 degrees for s-polarized and p-polarized light compared with random (unpolarized) light across the visible spectrum. Due to the geometry of lines of sight from an example 11 inch high display to the eye, the actual incidence angle on the beamsplitter will vary from about 45 degrees at the center to about 30 degree at the bottom and about 60 degrees at the top as previously described. Thus, the split between reflected and transmitted light will vary from the values shown above. Rather than employing diagonal polarization in a stereoscopic display, to minimize the losses in a 45 degree beam splitter device, the image to be reflected should be s-polarized and the image to be transmitted should be p-polarized. Applying this to the configuration of FIG. 1A, the back monitor should be vertically polarized, and the side monitor should be horizontally polarized.

FIG. 1F illustrates an enhanced brightness display employing a BSD 122 in a stereoscopic three-dimensional display system 120. The rear display 128A includes a p-polarizer 126A on its front for maximizing the image light transmitted through the BSD 122 to the observer 112 (obtaining greater than 50% transmittance). The side display 128A includes an s-polarizer 126B on its front for maximizing the image light reflected off the BSD 122 to the observer 112 (obtaining greater than 50% reflectance). It should be noted that the side display 128B may be disposed in any position, top, bottom, left or right relative to the common viewing aperture with the BSD 122 appropriately oriented to reflect the image of the side display 128B. As described above, the side display 128A may be properly polarized (and image flipped) by simply reversing the LCD panel of the standard display. Since an uncoated glass would be biased to transmit much more p-polarized light than reflect s-polarized light, one or more optical coatings 124 known in the art may be applied to the BSD 122 to balance the p-polarized transmittance and the s-polarized reflectance, maximizing both. Thus, the output stereoscopic image to the observer 112 achieves enhanced brightness over a conventional display that would only capture 50% of the image light reflected from the side display and 50% of the image light transmitted from the rear display at most.

3. Stereoscopic Three-Dimensional Display System

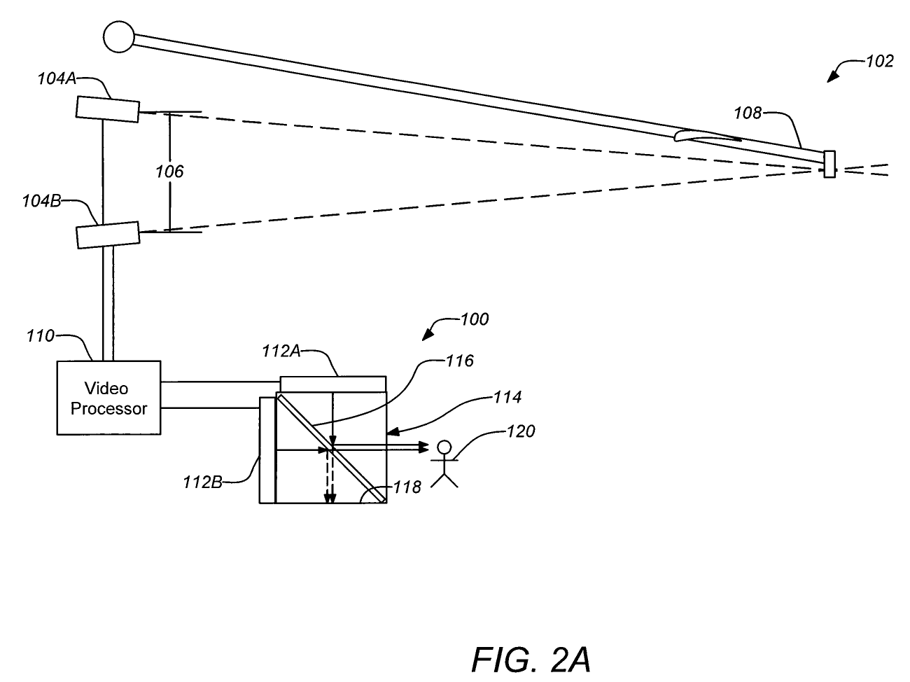

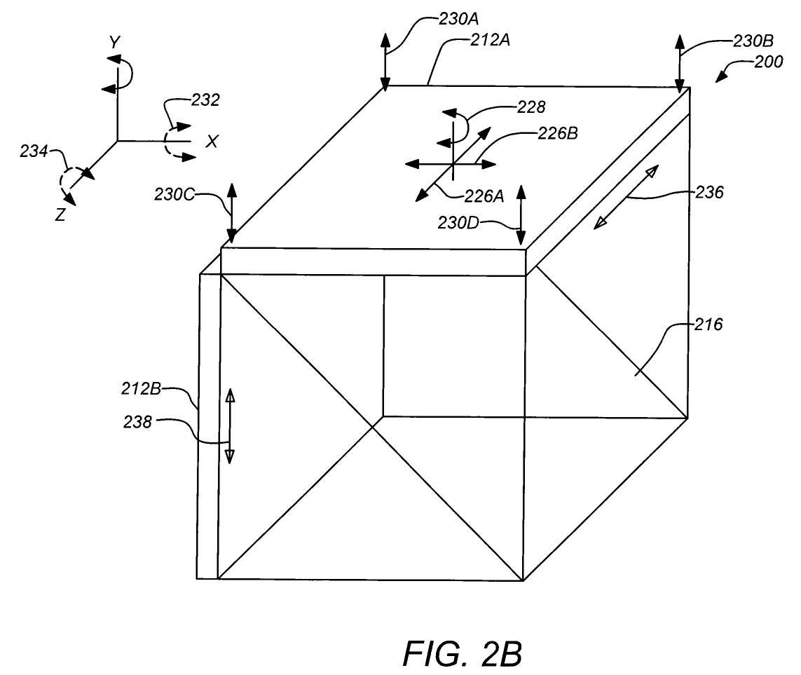

FIGS. 2A and 2B illustrates an exemplary display system 200 incorporating enhanced brightness in accordance with the invention. Referring first to FIG. 2A, the alignable display system 200 receives image input from a stereoscopic camera system 202 comprising two cameras 204A, 204B disposed in specific relationship to provide images of virtually the same view from slightly differentiated vantage points. One key parameter of the camera geometry is the separation distance 206 between the two cameras 204A, 204B. However, many other factors in the camera configuration also play a role in determining the optimum alignment relationship which must then be translated into the proper alignment of the stereoscopic three-dimensional display elements. For example, the cameras 204A, 204B may be canted toward each other (i.e. toed in) slightly to establish a convergence point. The optimal convergence point (if any) will depend upon the intended application as well as the particular cameras 204A, 204B being used. In addition, the selected cameras 204A, 204B have a range of variables (e.g. the lens geometry) which can impact the ideal alignment of the displays. Those skilled in the art can develop the appropriate camera selection and arrangement for the intended application. Similarly, those skilled in the art can develop the associated optimized alignment for the applied alignable display system 200 which will receive the input from the stereoscopic camera system 202. Embodiments of the invention are directed to the efficient application of that knowledge into aligning the display system 200.

For example, in one particular application, the sterescopic camera system 202 may be designed to provide a view of a remotely controlled aircraft appendage 208, e.g. such as a refueling boom of a tanker aircraft. The sterescopic camera system 202 provides video input which is properly aligned in the alignable display system 200 to present a real time stereoscopic video of the aircraft appendage with exceptional clarity.

The separate camera input from the cameras 204A, 204B is communicated to a video processor 210 which prepares the separate camera signal input for their respective displays 212A, 212B. The video processor 210 may comprise one or more separable units to perform a range of video processing functions such as video switching between multiple different camera systems 202, each having a potentially different camera configuration and requiring different alignments of the stereoscopic display system 200. Note that only one camera system 202 is shown; other camera systems are similar, but designed for other sterescopic applications. During alignment of the display system 200, the video processor 210 can generate the separate test patterns which are shown on each display 212A, 212B to be superimposed by the BSD 216 through the common viewing aperture 214.

In order to achieve enhanced brightness of the output stereoscopic image, embodiments of the invention shall implement a BSD and displays according to the parameters and principles taught in the section 2, e.g. as described regarding the display 120 of FIG. IF. The alignable display system 200 includes two separate displays 212A, 212B arranged so that their delivered images are superimposed through a common viewing aperture 214 to an operator. Superimposing the delivered images may be accomplished through the use of a beam splitter device 216 known in the art. The beam splitter device (BSD) 216 essentially comprises a partially silvered mirror (which may also employ special coatings one or both surfaces). The BSD 216 reflects a significant portion of the incident light from the top-mounted display 212A through the common viewing aperture 214 to deliver its image to the common viewing aperture 214 (although some light is transmitted through the BSD 216 to be absorbed by a black backwall 218. Simultaneously, a significant portion of the light from the back-mounted display 212B is transmitted through the BSD 216 and through the common viewing aperture 214 to deliver its image superimposed with that from the top-mounted display. In a similar manner, some light from the back-mounted display 212B is reflected off the BSD 216 to be absorbed by the black wall 218. Importantly, the two separate displays 212A, 212B deliver differently polarized images through the common viewing aperture 214. The different polarizations of the superimposed images are used to isolate the respective images from the displays 212A, 212B to the separate eyes of the operator 220 when the display system 200 is being used. The displays 212A, 212B may be CRTs or LCDs or any other display technology known in the art capable of being filtered or directly generating a polarized image output. Special glasses having lenses with matching polarized filters (one for each eye) may be used to accomplish this as is known in the art.

In addition, the sterescopic display system 200 may also be accurately aligned by employing a superimposed view of both images (e.g. test patterns) from the separate displays 212A, 212B. Efficient alignment of the sterescopic display system 200 can be achieved through a number of techniques as taught in U.S. application Ser. No. ______ by Merritt et al., filed on this same day herewith and entitled “EFFICIENT AND ACCURATE ALIGNMENT OF STEREOSCOPIC THREE-DIMENSIONAL DISPLAYS,” which is incorporated by reference herein. Some adjustment controls for separate displays can be used to facilitate precise alignment of the system 200.

FIG. 2B illustrates exemplary physical alignment controls which may be implemented for the top display 212A of the sterescopic three-dimensional display system 200. Physical alignment controls enable separate adjustment of the horizontal translation 226A and the vertical translation 226B as well as the rotation 228 (about the Y axis) of the display 212A. In addition, each corner of the display may be separately adjusted in a Y axis translation 230A-230D. The combined effect of the corner Y axis translations 230A-230D is to effect small rotations (canting) of the display 212A about the X axis 232 and or Z axis 234 as shown. Principally, the corner Y axis translations 230A-230D may be used to align the displays to eliminate keystone distortions. The same set of physical alignment controls may be relatively applied to the rear display 212B as well (not shown). Furthermore, in the example embodiment, the top display 212A may present horizontally polarized images (as indicated by the arrow 236) while the rear display 212B presents vertically polarized images (as indicated by the arrow 238).

4. Example Stereoscopic Three-Dimensional Display

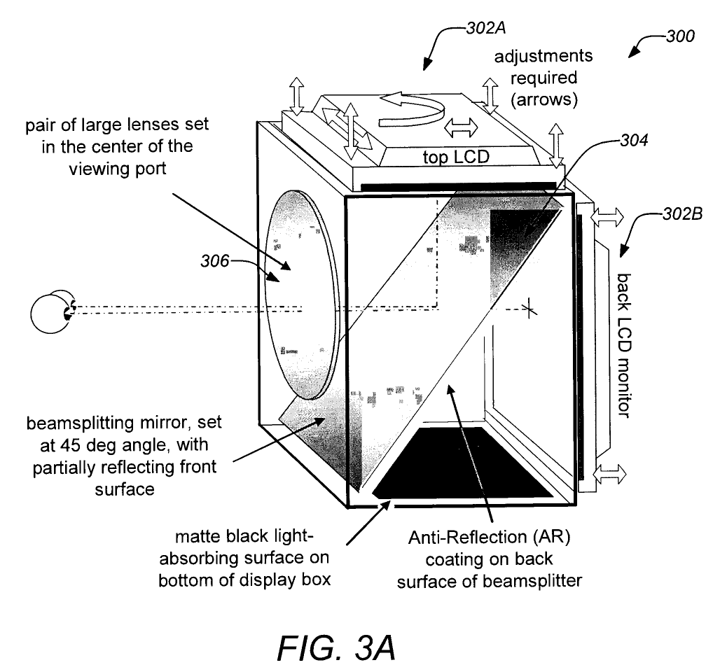

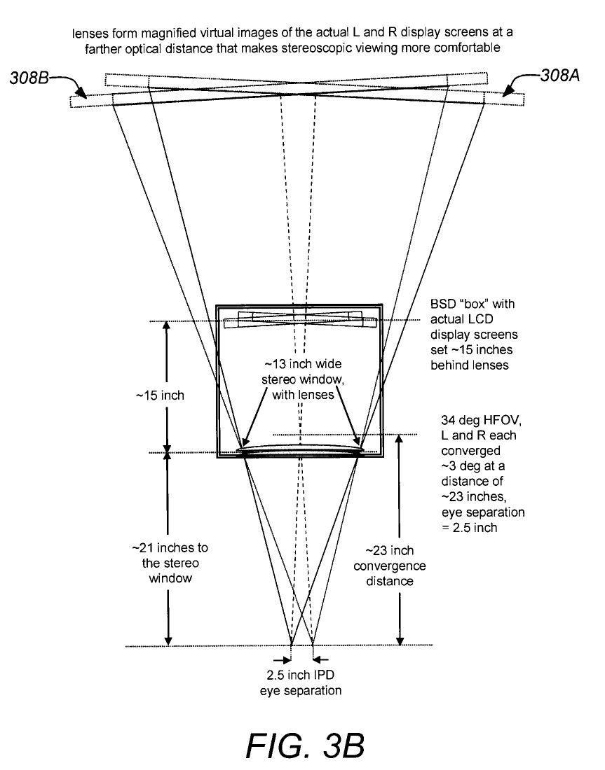

FIGS. 3A and 3B illustrates an exemplary structure 300 of a stereoscopic three-dimensional display incorporating stereoscopic alignment in accordance with the invention based upon a particular camera geometry application. FIG. 3A illustrates principal display components in an exemplary embodiment of the invention. The structure 300 of an exemplary embodiment of the invention shows the dual LCD displays 302A, 302B used with the beamsplitter 304 to produce the stereoscopic display. The side LCD display 302A is seen reflected in the beamsplitter 304, while the back LCD display 302B is seen directly through the beamsplitter 304. Here also, the beamsplitter 304 and the LCD displays 302A, 302B are designed as described in section 2 above, e.g. FIG. IF, to exhibit enhanced brightness. For example, the side display 302A is s-polarized and reflects its image to the common viewing aperture and the rear display is p-polarized and transmits its image to the common viewing aperture. In addition, the beamsplitter 304 is coated to substantially balance (and maximize) the brightness of the s-polarized reflected image and that of the p-polarized transmitted image from the side display 302A and rear display 302B, resepectively. The large viewing lenses 306 form virtual images of the two LCD displays 302A, 302B, providing a farther viewing distance, which is important for visual comfort when viewing stereoscopic images for longer periods of time.

FIG. 3B shows the complexity of the alignments required in an exemplary embodiment of the invention. The left and right display screens 302A, 302B should appear as virtual images approximately 65 inches from the operator's two eyes, separated and canted by about 3 degrees each, with the left and right lines of sight to the center pixels converged at approximately 23 inches from the eyes in order to match the imaging geometry of the exemplary camera system. The imaging system incorporates two video cameras, each with 34 deg horizontal field-of-view (HFOV), with camera optical axes converged by approximately 6 degrees, thus requiring matching convergence of the user's left and right eyes when fixating the center pixels of the left and right display screen images.

The exemplary design is directed to providing a comfortable two-channel stereoscopic three-dimensional video display that creates an ortho-stereoscopic percept of the refueling boom and receiver aircraft in the user's binocular visual space, scaled down by a hyper-stereo scale factor equal to the ratio between the camera separation and the user's eye separation. In the exemplary embodiment, the left and right cameras may be separated by approximately 17 inches, which is a scale factor of 6.8 times the average human eye separation of 2.5 inches. Key considerations include avoiding the so-called “stereo window frame violation”, and ensuring that the user's eyes are not required to diverge beyond parallel when fixating distant objects in the scene, and minimizing “focus/fixation” mismatch between the distance at which the user's eyes are converged or fixated and the distance at which the user's eyes have to focus when viewing the displayed images.

The exemplary two-channel stereoscopic three-dimensional display system uses a beam-splitter between to displays to create in binocular perceptual space the equivalent of two virtual display screens that have an optical distance of approximately 0.67 diopters (approximately 5 feet from the eyes), with a 34 degree horizontal field-of-view subtended by the central 1024 pixels in each eye's virtual display screen as shown in FIG. 3B. The lines of sight of the left and right eyes to the center pixels of the two left and right virtual display screens 308A, 308B are converged at a distance of approximately 23 inches from the mid-point between the two eyes (6.2 degree convergence angle, assuming a 2.5 inch inter-pupillary distance (IPD) for the average user. The edges of the two horizontal fields of view intersect to form an approximately 13-inch-wide stereo window approximately 21 inches from the eyes along display system centerline. The purpose of doing this is to avoid so-called stereoscopic “frame violations” where the viewed aircraft appendage may intersect the top of the stereo window. This difference between the focus (approximately 5 feet) and the convergence (approximately 23 inches) departs from traditional stereo display design, in which ocular focus and display convergence are usually matched at the same distance. The rationale for this is discussed hereafter.

In the exemplary stereoscopic three-dimensional system, the stereoscopic window is positioned by converging the two camera optical centerlines at a distance of approximately 13 feet (by toe-in of the cameras rather than by laterally sliding the sensor chips), which is the optical centerline distance at which the refueling boom intercepts the upper edge of the camera field of view. Since the left and right camera lenses may be separated by 17 inches in order to enhance depth acuity, (forming a convergence angle of 6.2 degrees), the two display modules in the BSD should be converged or “canted” to the same 6.2 degree angle, to minimize keystone distortion of binocular visual space. The optical distance of the display modules may be set to 0.67 diopters (approximately 5.5 ft) because the operator will spend most of the time viewing a distance of approximately 52.4 feet in the design application (which will appear to be approximately 7.7 feet in the 1/6.8 “scale model” view created by the hyper-stereo camera separation).

The exemplary embodiment comprises a hyper-stereoscopic video display to provide enhanced depth perception for the boom operator when performing aerial refueling. The display obtains a left and right stereoscopic pair of retinal images by means of the BSD rather than from a single shuttered stereoscopic panel-mounted CRT display, as in other previous systems. This difference should help minimize certain problems encountered with the previous shuttered display.

Previous system's using panel-mounted stereoscopic displays employed an electrically switchable polarizing shutter screen over a single CRT display faceplate. This permitted the use of passive polarized glasses for the operators, but there was some “ghosting” or cross-talk between the left and right images. Since the left-eye and right-eye imagery are no longer shuttered on the same screen in this example embodiment by employing separate polarized LCD displays, ghosting due to residual image decay is no longer present. However, there may still be some ghosting with the two-display BSD system due to “leakage” in the polarizing filters used to separate the left and right views for each eye, and thus quality of the optical means used to separate the left and right views, is important.

To minimize the adverse effects of ghosting, and to provide for a visually workable display in the event of shutter failure, the previous systems have converged the left and right cameras at the distance where the primary observation is to occur in the intended application, e.g. the location where a refueling appendage will dock. This convergence, however, created a visually disturbing stereoscopic effect: Operators have complained that it appeared unnatural for the refueling boom, which appeared to be sticking out in front of the stereo window, to be cut off by the top of the stereo window, which was seen as being behind it. This was due to the convergence of the cameras at the distance of the center of the viewing envelope, about 60 feet from the cameras. Everything in the scene that was closer than that convergence distance, particularly the aircraft appendage, would appear in stereoscopic depth to be in front of the display screen window.

This well-known problem in stereoscopic display design is often referred to as a “frame violation,” or “window violation,” which occurs when an virtual three-dimensional object is closer than the stereoscopic display window frame, but is paradoxically cut off by the frame behind it. In normal “direct” viewing, a window frame cuts off only those objects behind the window, and thus it can appear unnatural and perceptually disturbing for the stereo window (usually corresponding to the edges of the display) to cut off three-dimensional objects that appear to be in front of the window.

In the exemplary embodiment, the BSD affords the opportunity to create a stereoscopic window frame that naturally appears at an optical distance just in front of the closest object in the scene, e.g. the aircraft appendage at the point where it disappears from view at the center of the upper edge of the stereoscopic display window. In doing this, the left and right BSD displays are canted so their optical centerlines cross at approximately 23 inches from the user, creating a stereoscopic window frame that is about 21 inches from the observer's eyes.

Generally, to avoid “frame violations” in a stereoscopic display, the left and right display windows may be “converged”, by various techniques, to make the edges of the stereo window appear in front of the scene objects that are cut off by the window. However, if the optical distance of the individual display elements is behind the window (in order to minimize focus/fixation mismatch when viewing objects through the window), the stereo window edges will still appear in sharp focus, inconsistent with their binocularly doubled appearance.

The “mid-window” concept involves creating a physical aperture at the location of the stereo window with an optical distance that is consistent with its apparent binocular distance, and thus it appears naturally blurred when looking “through” the stereo window at more distant objects in the scene. This mid-window concept involves the use of a BSD with a “mid-window aperture” inserted between the display screen and the observer. Basically, the BSD physical mid-window, placed between the physical display and the viewing aperture, creates a more natural stereoscopic frame by giving observers natural focus cues as well as binocular fixation cues that are consistent with looking through an actual window at more distant objects of interest in the scene.

The toe-in method of converging the cameras and BSD modules is used because both left and right cameras must be identical, with no horizontal shift of lens or sensor chip relative to each other. The generally preferred method of convergence by the lateral shift method would require symmetrically opposite shifts in the left and right cameras, and that would require two different types of cameras, a “left” and a “right” version. It is generally recognized that lateral shifting of the lenses or chips as a means of convergence is superior to the toe-in method of convergence; however, toe-in, with its attendant complexities of imaging geometry, allows use of a single camera type. This requires toe-in as the method for corresponding convergence of the left and right BSD modules, as is presently done in some existing BSD units by canting the left and right modules inward to match the toe-in convergence angle of the left and right cameras.

The complex display alignment requires precise positional adjustments of displays and other components. Note the lateral shift and rotation of the virtual images of the display screens, required to make display geometry match camera geometry. This can be tedious and inaccurate without proper test patterns on the screens.

5. Method of Enhancing Brightness of a Stereoscopic Display System

Embodiments of the invention also encompass a method of cooling an electronic circuit consistent with the foregoing apparatus. The initial object is to form a hermetic cavity over the electronic circuit to be cooled and partially fill it with an appropriate non-conductive fluid. However, the use of the outer frame and flexure significantly improve the technique.

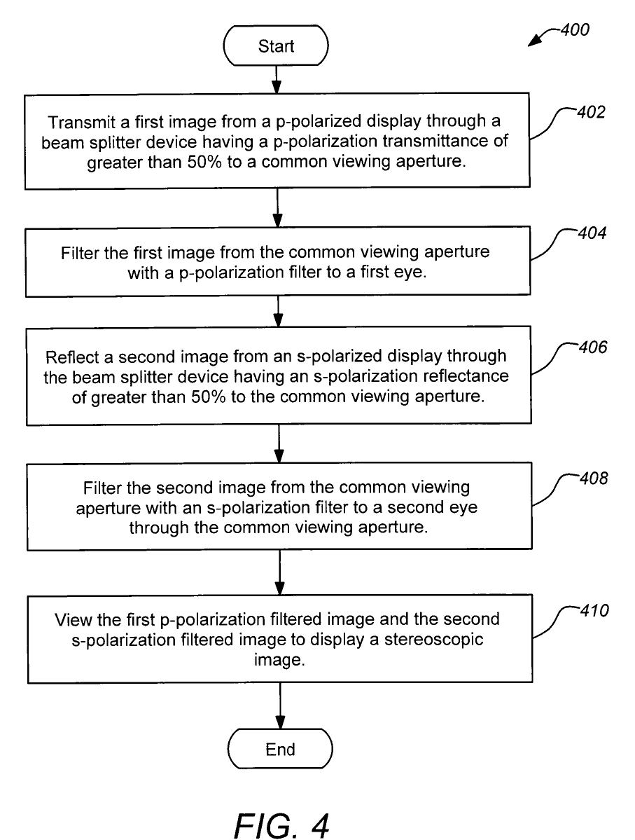

FIG. 4 is a flowchart of an exemplary method 400 for displaying a stereoscopic three-dimensional image with enhanced brightness. The method 400 begins with an operation 402 of transmitting a first image from a p-polarized display through a beam splitter device having a p-polarization transmittance of greater than 50% to a common viewing aperture. Next, in operation 404, the first image from the common viewing aperture is filtered with a p-polarization filter to a first eye. In operation 406, a second image from an s-polarized display is reflected through the beam splitter device having an s-polarization reflectance of greater than 50% to the common viewing aperture. Following this, in operation 408, the second image from the common viewing aperture is filtered with an s-polarization filter to a second eye through the common viewing aperture. Finally, in operation 410 the first p-polarization filtered image and the second s-polarization filtered image are viewed to display a stereoscopic image.

The method 400 may be further modified consistent with the various apparatus embodiments previously described. For example, the beam splitter device may include an optical coating to substantially balance the p-polarization transmittance with the s-polarization reflectance. Thus, the brightness of the stereoscopic image may be maximized. Further, in a typical embodiment the p-polarization transmittance and the s-polarization reflectance can each be at least 60%. The p-polarized display and the s-polarized display each may comprise an LCD display. In addition, the stereoscopic image can be viewed through one or more lenses disposed in the common viewing aperture. In one example, two plano-convex lenses can be employed in the common viewing aperture to increase the apparent size of the stereoscopic image to the viewer.

This concludes the description including the preferred embodiments of the present invention. The foregoing description including the preferred embodiment of the invention has been presented for the purposes of illustration and description. It is not intended to be exhaustive or to limit the invention to the precise forms disclosed. Many modifications and variations are possible within the scope of the foregoing teachings. Additional variations of the present invention may be devised without departing from the inventive concept as set forth in the following claims.

What is claimed is:

1. An apparatus for a three-dimensional stereoscopic display comprising:
a beam splitter device having a p-polarization transmittance of greater than 50% and an s-polarization reflectance of greater than 50%;
a p-polarized display disposed to transmit a first image through the beam splitter device to a common viewing aperture;
an s-polarized display disposed to reflect a second image through the beam splitter device to the common viewing aperture;
wherein the first image is p-polarization filtered to a first eye and the second image is s-polarization filtered to a second eye through the common viewing aperture to display a stereoscopic image.

2. The apparatus of claim 1, wherein the beam splitter device includes an optical coating to substantially balance the p-polarization transmittance with the s-polarization reflectance.

3. The apparatus of claim 1, wherein the p-polarization transmittance is at least substantially 60% and the s-polarization reflectance is at least substantially 60%.

4. The apparatus of claim 1, wherein the s-polarized display comprises an LCD panel reversed relative to a backlight.

5. The apparatus of claim 1, wherein the beam splitter device is disposed at substantially forty-five degrees relative to both the p-polarized display and the s-polarized display.

6. The apparatus of claim 1, wherein the p-polarized display and the s-polarized display each comprise an LCD display.

7. The apparatus of claim 1, wherein the p-polarized display is disposed behind the beam splitter device and the s-polarized display is disposed on one side of the beam splitter device.

8. The apparatus of claim 1, further comprising one or more lenses disposed in the common viewing aperture.

9. The apparatus of claim 8, wherein the one or more lenses comprise two plano-convex lenses.

10. A method for a three-dimensional stereoscopic display comprising:
transmitting a first image from a p-polarized display through a beam splitter device having a p-polarization transmittance of greater than 50% to a common viewing aperture;
filtering the first image from the common viewing aperture with a p-polarization filter to a first eye;
reflecting a second image from an s-polarized display through the beam splitter device having an s-polarization reflectance of greater than 50% to the common viewing aperture;
filtering the second image from the common viewing aperture with an s-polarization filter to a second eye through the common viewing aperture; and
viewing the first p-polarization filtered image and the second s-polarization filtered image to display a stereoscopic image.

11. The method of claim 10, wherein the beam splitter device includes an optical coating to substantially balance the p-polarization transmittance with the s-polarization reflectance.

12. The method of claim 10, wherein the p-polarization transmittance is at least substantially 60% and the s-polarization reflectance is at least substantially 60%.

13. The method of claim 10, further comprising reversing an LCD panel reversed relative to a backlight for the s-polarized display.

14. The method of claim 10, wherein the beam splitter device is disposed at substantially forty-five degrees relative to both the p-polarized display and the s-polarized display.

15. The method of claim 10, wherein the p-polarized display and the s-polarized display each comprise an LCD display.

16. The method of claim 10, wherein the p-polarized display is disposed behind the beam splitter device and the s-polarized display is disposed on one side of the beam splitter device.

17. The method of claim 10, further comprising one or more lenses disposed in the common viewing aperture.

18. The method of claim 17, wherein the one or more lenses comprise two plano-convex lenses.

19. An apparatus for a three-dimensional stereoscopic display comprising:
a beam splitter device means for transmitting greater than 50% p-polarized incident light and for reflecting greater than 50% s-polarization reflectance;
a p-polarized display means for transmitting a first image through the beam splitter device means to a common viewing aperture;
an s-polarized display means for reflecting a second image through the beam splitter device means to the common viewing aperture;
wherein the first image is p-polarization filtered to a first eye and the second image is s-polarization filtered to a second eye through the common viewing aperture to display a stereoscopic image.

20. The apparatus of claim 1, wherein the beam splitter device includes an optical coating to substantially balance the p-polarization transmittance with the s-polarization reflectance.
